(19) United States
(12) Patent Application Publication
(10) Pub. No.: US 2025/0065498 A1
(43) Pub. Date: Feb. 27, 2025

(54) Reducing Kinematic Error

(71) Applicant: ABB Schweiz AG, Baden (CH)

(72) Inventors: Arne Wahrburg, Weiterstadt (DE); Richard Roberts, Gilching (DE); Stig Moberg, Västerås (SE); Nima Enayati, Mannheim (DE)

(73) Assignee: ABB Schweiz AG, Baden (CH)

(21) Appl. No.: 18/948,710

(22) Filed: Nov. 15, 2024

Related U.S. Application Data
(63) Continuation of application No. PCT/EP2022/063354, filed on May 17, 2022.

(51) Int. Cl. B25J 9/16

(52) U.S. Cl. CPC B25J 9/1641; B25J 9/1653

(57) ABSTRACT

A method includes determining a movement of a robot arm in which a joint while being rotated from a start angle to an end angle, is subject to a constant gravity-induced torque; controlling execution of the movement, and, in the movement, controlling the joint to rotate from the start angle to the end angle at a constant speed; detecting speed fluctuations of the joint while it is being rotated from the start angle to the end angle; and estimating the kinematic error based on the speed fluctuations.

### CROSS-REFERENCE TO RELATED APPLICATIONS

The instant application claims priority to International Patent Application No. PCT/EP2022/063354, filed May 17, 2022, which is incorporated herein in its entirety by reference.

### FIELD OF THE DISCLOSURE

The present disclosure generally relates to systems and methods for reducing kinematic error when controlling the movement of a joint in an articulated robot arm.

### BACKGROUND OF THE INVENTION

An articulated robot arm comprises a plurality of links, which are coupled to each other, to a base or to an end effector by rotatable joints. Rotation of such a joint is driven by a motor, typically via a transmission gear. Play and inaccuracy in the manufacture of the motors and gears affects the accuracy with which the position and the speed of an end effector at the distal end of the robot arm can be controlled. Harmonic drive gears are widely used as transmission gear in robots, since they are practically backlash-free and achieve high reduction ratios. However, inevitable inaccuracies, such as eccentricity of a gearwheel or spline, would still cause the rotation speed of a joint to fluctuate even if its motor could be driven at a perfectly constant speed, so that the position of the joint can deviate from what one would expect based on knowing the position of the motor and the reduction ratio of the gear. This deviation is commonly referred to as kinematic error or transmission error.

### BRIEF SUMMARY OF THE INVENTION

The present disclosure describes a simple and cost efficient way of assessing and compensating kinematic error in a robot joint. In one aspect, the disclosure describes a method for assessing kinematic error in a joint which rotatably connects a proximal portion and a distal portion of a robot arm, the robot joint having associated with it a motor mounted in one of said portions and coupled to the other one of said portions for driving rotation of the joint by a transmission gear, and a sensor for measuring the rotation of the joint, the method comprising the steps of:
(a) determining a movement of the robot arm in which the joint, while being rotated from a start angle to an end angle, is subject to a constant gravity-induced torque;
(b) controlling execution of said movement, and, in said movement, controlling the joint to rotate from the start angle to the end angle at a constant speed;
(c) detecting speed fluctuations of the joint while it is being rotated from the start angle to the end angle; and
(d) estimating the kinematic error based on the speed fluctuations.

By keeping the gravity-induced torque constant, it can be ensured that speed fluctuations are indeed due to imperfections of the gear, or, at least, are not biased by gravity-induced deformation of the robot arm.

### BRIEF DESCRIPTION OF THE SEVERAL VIEWS OF THE DRAWING(S)

FIG. 1 is a block diagram of a robotic system in accordance with the disclosure.

FIG. 2 is a perspective view of the robot arm of the system of FIG. 1.

FIG. 3 illustrates steps of a movement for measuring the kinematic error of a first joint of the robot arm of FIG. 2.

FIG. 4 illustrates steps of a movement for measuring the kinematic error of a second joint of the robot arm of FIG. 2 in a first angle range.

FIG. 5 illustrates steps of a movement for measuring the kinematic error of the second joint in a second angle range.

FIG. 6 illustrates a pose of the robot for measuring the kinematic error of the third and fourth joints.

### DETAILED DESCRIPTION OF THE INVENTION

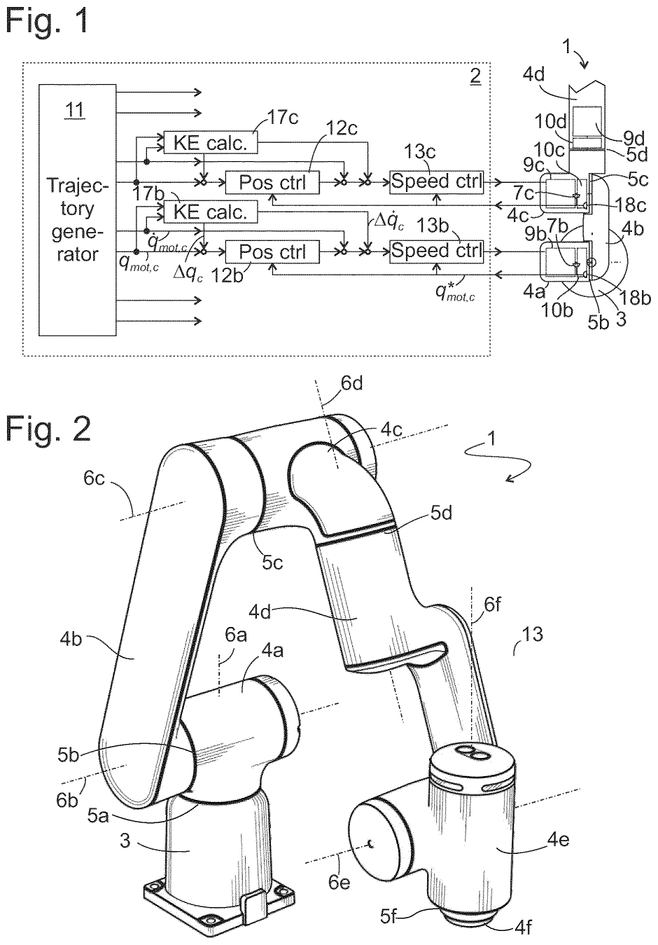

FIG. 1 is a schematic view of a robot system comprising an articulated robot arm 1 and a controller 2. The robot arm 1, shown in more detail in FIG. 2, has a stationary base 3 fixed to a support, and a plurality of links 4a-4f rotatably connected to each other and to the base 2 by joints 5a-5f. The joint 5e connecting links 4d, 4e is concealed behind link 4e. Each joint 5i, where i=a . . . f, enables a rotation of the link 4i on its distal side by an axis 6i. The most distal link 4i is a holder for a replaceable tool, not shown. Axis 6a is vertical, axes 6b and 6c are horizontal; the orientations of the other axes vary. Each joint 5i has a motor associated with it for driving its rotation; the motor can be provided in a member on the proximal side of the joint and be connected to a member on the distal side thereof, or vice versa. In the robot arm of FIG. 2, joints 5a, 5b, 5f have their motors in members on their proximal side, i.e. base 3 and links 4a, 4c, respectively; joints 4c, 4d and 4e have the motors on their distal side, in links 4c, 4d and 4c, respectively.

Motors 9b, 9c, 9d associated with joints 5b, 5c, 5d and transmission gears 10b, 10c, 10d connecting these motors to links 4b, 4b and 4c, respectively, are shown in FIG. 1.

Typically, the transmission gear 10j is a harmonic gear in which a wave generator is rigidly coupled to an output shaft of motor 9j, and pressing teeth of a flex-spline into local engagement with a circular spline surrounding it. When the number of teeth of the circular spline is i_{c} and that of the flex spline is if, the reduction ratio of the gear 10ⱼ is

$${R}_{j} = \frac{{i}_{f} - {i}_{c}}{{i}_{f}} .$$

Since the flex-spline is rotating in a direction opposite to that of the wave generator, points of the two currently in contact will meet again after the wave generator has rotated by 2πⁱ^{_{f}}/i_{c}. The controller 2 comprises a trajectory generator 11 and, associated with each joint 4j, j=a, b . . . f, a position controller and a speed controller, of which only position controllers 12b, 12c, and speed controllers 13b and 13c are shown. A trajectory specifies, as a function of time, coordinates a reference point of the robot arm, usually referred to as the tool center point TCP is to have at specified times in the course of a movement the robot is to reproduce. The trajectory generator 11 stores such a trajectory and, when triggered to reproduce it, outputs, at each instant t in time, angle commands to the position controllers 12j that specify an angle q_{arm j}^{target}(t) which, according to the trajectory, should be assumed by their associated joint 5j at that instant.

Each position controller 12j is connected to a feedback line which conveys a signal representative of the current position or rotation speed of its associated joint 4j. The signal can originate from different sources. Conventionally, and as shown in FIG. 1, the source is an angle sensor 7j, e.g. a resolver, which is associated with an output shaft of motor 9j driving transmission gear 10j, and detects a rotation angle q_{mot j} of the output shaft.

The position controller 12j produces an output signal which is a sum of terms proportional to the difference between a desired current position q_{mot j} of the motor derived target from the joint target angle q_{arm j}^{target} specified by the trajectory generator 11 under the assumption that both are strictly proportional and the actual current motor position q*_{mot,j} derived from the signal of feedback line 14b, 14c. The output signal might be used directly for controlling input power to the motor 9a, 9b; in the case of FIG. 1 it is input to speed controller 13b, 13c which compares it to a current joint speed derived from the signal of sensor 7b, 7c, and controls motor input power based on the difference so that when the target desired current position q_{arm,j}^{target}(t) specified by the trajectory generator 11 changes at a constant rate with time t, the position q_{mot,j} of the motor output shaft does so, too.

If the reduction ratio Rⱼ of the transmission gear 10j was independent of the motor angle, a current joint angle q*_{arm,j} of joint 5j could be calculated from a measured value q*_{mot,j} of the motor angle using q**ₐᵣₘⱼ=Rⱼq*_{mot,j}+q₀ (q₀ being a constant phase angle) with higher precision than it could be measured directly at the joint 5j itself. In fact, imperfections of the reduction gear 10j cause the reduction ratio Rⱼ to vary slightly as a function of q_{mot j}.

Another angle sensor 18j is associated with an output shaft of the transmission gear 10j, so as to obtain measured values q*_{arm,j} of the joint angle directly and without any transmission gear in between.

The variation of the reduction ratio iⱼ is detected from outputs of the sensors 7j, 18j by forming the difference, also referred to as kinematic error, Δqⱼ(q_{mot j})=q*ₐᵣₘⱼ−(Rⱼq_{mot j}+q₀) where q*_{arm,j} is measured at the same time as q_{mot,j} is output. Alternatively, the variation might be derived from a time shift between the instant in which the joint angle, calculated from the motor angle as q_{arm,j}=Rⱼq_{mot,j}+q₀ reaches a given value and the instant in which this value is actually measured.

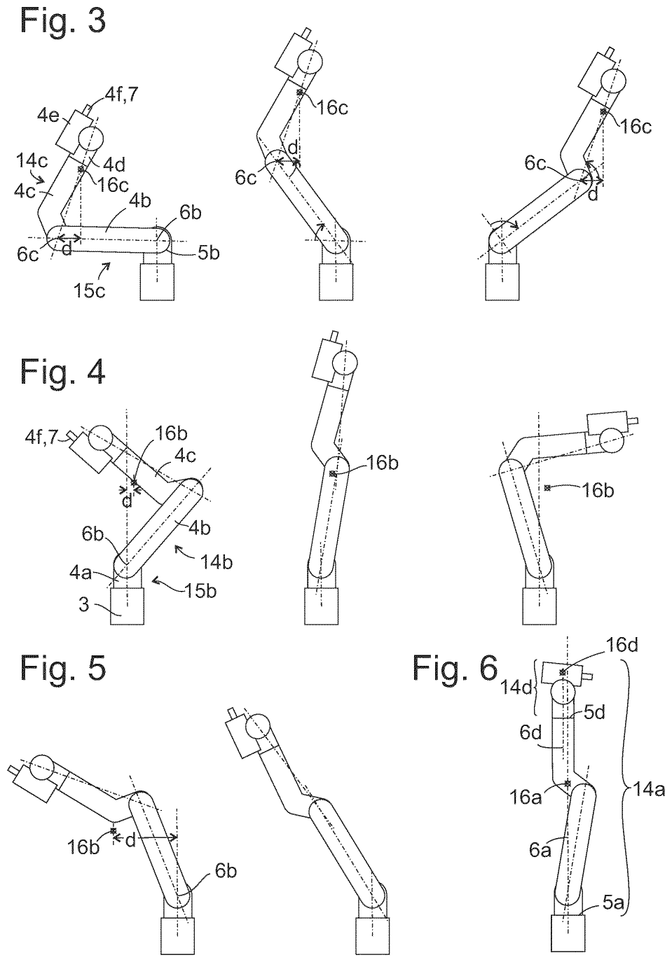

FIG. 3 shows poses adopted by the robot arm 1 in the course of a trajectory used for assessing the kinematic error of joint 5c. With respect to this joint 5c, members 4c, 4d, 4c, 4f form a distal portion 14c, whereas elements 3, 4a and 4b form a proximal portion 1Sc of robot arm 1. In the trajectory of FIG. 3, link 4b is rotated clockwise around axis 6b, whereas the distal portion 14c is rotated counterclockwise around axis 6c by the same angle. Both axes 6b, 6c are parallel, so that with respect to a coordinate system in which the base 3 is stationary, the distal portion 14c is displaced along a circular path but does not rotate. Thus, a lateral offset d between axis 6c and the center of gravity 16c of distal portion 14c remains constant through the entire trajectory, and so does the torque to which joint 4c is subjected while the distal portion 14c is being rotated. All other joints 4a, 4d-f do not rotate throughout the trajectory.

When motor 9c is controlled to rotate at a constant speed \dot{q}_{mot,c} too, all spectral components of the kinematic error Δq_{c} at frequencies higher than the fundamental frequency of rotation of the joints Sb, Sc can be regarded as due to speed variations resulting from imperfections of transmission gear 10c.

The kinematic error is approximated by a sum of harmonic functions

$$Δ {q}_{c} = {\sum }_{i = 1}^{M} {A}_{i , c} sin ( {k}_{i , c} {q}_{mot j} + {ϑ}_{i , c} ) \qquad ( 1 a )$$

$$or$$

$$Δ {q}_{c} = {\sum }_{i = 1}^{M} {B}_{i , c} sin ( {k}_{i , c} {q}_{mot , j} ) + {C}_{i , c} cos ( {k}_{i , c} {q}_{mot , j} ) \qquad ( 1 b )$$

wherein k is either an integer or an integer multiple of i_{f}/i_{c}.

While controller 2 moves the robot arm 1 as described above, it collects measurements of Δq_{c}(qₘₒₜ_{ₛ}), and numerically fits the adjustable parameters A_{i,c}, ϑ_{i,c} or B_{i,c}, C_{i,c} in equations (1a) or (1b) to these measurements. Typically, the most important contributions to the sums of equations (1a) or (1b) are for k₁=2ⁱ^{_{f}}/i_{c} and k₂=2. In practice, it may therefore be sufficient to perform the fit for these two components alone, or, possibly, one or two more components at higher frequencies k₃ or k₄.

The adjustable parameters thus obtained are written into a kinematic error (KE) calculator 17c, enabling it determine, for any target angle output by trajectory generator 11, the corresponding kinematic error and its time derivative. By superimposing these upon the commands from the trajectory generator, the kinematic error is largely compensated, and the precision with which the displacement of the robot arm 1 is controlled can be improved considerably.

FIG. 4 shows poses adopted by the robot arm 1 in the course of a trajectory used for assessing the kinematic error of joint 5b. In this trajectory, link 4b is rotated counterclockwise around axis 6b. Proximal portion 15b is comprises only base 3 and link 4a, links 4b to 4f form distal portion 14b. The center of gravity 16b of distal portion 14b has a small lateral offset d from axis 6b. In order to hold the torque acting on joint 5c constant, the displacement d must be constant while link 4b is rotated. This is achieved by rotating link 4c and all other more distal links clockwise around axis 6c.

As described above, while the robot arm 1 is moved along the trajectory, the controller collects kinematic error data Δq_{b}(q_{mot,b}) from sensors 7b, 18b in order to assess the kinematic error of joint 5b.

While in the trajectory of FIG. 3, joint 5c can rotate by 180° or even more while holding constant the gravity-induced torque applied by distal portion 14c, the angle by which joint 5b can rotate under constant torque from distal portion 14b is much smaller, approximately 60°, and covers only a fraction of the range in which the joint Sb is actually free to rotate. In order to assess the kinematic error for a wider range of angles, the robot arm 1 can assume poses as shown in FIG. 5: in the left-hand one of these the orientation of link 4b is similar to that in the right-hand pose of FIG. 4; links 4c-4f have been rotated to the left, placing the center of gravity 16b to the left of axis 6b. Link 4b can now continue to rotate counterclockwise, and links 4c-4f can again rotate clockwise, as shown in the right-hand pose of FIG. 5, again keeping the offset d constant, although at a value different from that of FIG. 4.

It should be noted that the transmission gear 10b, 10c . . . associated with each joint 5a-f of the robot arm 1 has a transmission ratio high enough so that while in the course of a trajectory the joint rotates through an angle range in which the gravity-induced torque acting on it can be held constant, the motor which drives the joint can carry out several complete revolutions. Any imperfections of the motor or of an input side of the transmission gear will take effect on the kinematic error at least once per revolution. So, while the robot arm is moving along the trajectory, the effect of such an imperfection can be observed several times, so that its frequency, phase and amplitude can be determined precisely.

FIG. 6 illustrates a pose of the robot arm 1 in which the center of gravity 16a of a distal portion comprising links 4a-f of a distal portion comprising links 4d-f is located on axis 6a. In this pose, the joint 5a can be rotated as far as desired, performing a complete revolution or even multiple revolutions. Since the gravity-induced torque acting on the joint 5a is constantly zero, any variations of the acceleration measured by sensor 7 while rotating around axis 6a can be attributed to imperfections of the transmission gear 10a or its associate motor 9a, and can be used as described above for assessing the kinematic error of joint 5a.

Further, axis 6d of joint 5d is vertically oriented, and the center of gravity 16a of a distal portion comprising links 4d-f is located on it, so that in analogy to joint 5a, joint 5d can be rotated and its kinematic error assessed in this pose.

In a general aspect, the present disclosure describes a method for assessing kinematic error in a joint which rotatably connects a proximal portion and a distal portion of a robot arm, the robot joint having associated with it a motor mounted in one of said portions and coupled to the other one of said portions for driving rotation of the joint by a transmission gear, and a sensor for measuring the rotation of the joint, the method comprising the steps of: (a) determining a movement of the robot arm in which the joint, while being rotated from a start angle to an end angle, is subject to a constant gravity-induced torque; (b) controlling execution of said movement, and, in said movement, controlling the joint to rotate from the start angle to the end angle at a constant speed, (c) detecting speed fluctuations of the joint while it is being rotated from the start angle to the end angle; and (d) estimating the kinematic error based on the speed fluctuations.

By keeping the gravity-induced torque constant, it can be ensured that speed fluctuations are indeed due to imperfections of the gear, or, at least, are not biased by gravity-induced deformation of the robot arm.

Fluctuations may be due to imperfections on the motor side of the transmission gear or on its arm side. When the reduction ratio of the transmission gear is high enough to require several revolutions of the motor for rotating the joint from the start angle to the end angle, the effect of a motor-side imperfection can be observed repeatedly while executing the movement, so that the influence of noise on the estimated kinematic error can be reduced.

While steps b) and c) are preferably carried out by a dedicated electronic controller, this doesn't have to be so for step a). In fact, in most practical cases an appropriate movement can be determined without elaborate optimization.

For example, when the joint in question can have its axis of rotation brought into a vertical orientation, the amount of the torque to which the joint is subjected by the weight of its associated distal portion will not vary during the rotation, provided that internal joints of the distal portion do not move.

The method may therefore comprise a step of bringing the axis of rotation into vertical orientation prior to step b).

Another important special case is where two joints have parallel axes of rotation (or where, in a preparatory step, the axes of two joints are aligned to be parallel). In the description of this special case, the joint referred to above will be called the first joint, and the other the second joint. In that case a rotation speed of the second joint can be matched to that of the first joint so that the gravity-induced torque to which the first joint is subjected is constant throughout the rotation.

Preferably, these axes of rotation are horizontal. When the second joint is in the proximal portion, the gravity-induced torque can be held constant by controlling the rotation of the second joint to be identical in speed but opposite in direction to the rotation of the first joint. When the second joint is in the distal portion, the gravity-induced torque can be held constant by rotating the first and second joints in opposite directions and controlling the speed of the second joint so as to keep constant a lateral displacement between the axis of the first joint and the center of gravity of the distal portion.

Since when the second joint is in the distal portion, the range of angles in which the first joint can be rotated while holding said lateral displacement constant is limited, it can be expedient to carry out step c) at least twice, under different lateral displacements and to base the estimation of step d) on data collected in said multiple steps c).

The speed of rotation should be low enough for torque induced by centrifugal and Coriolis forces to be small compared to gravity induced torque, preferably less than 10% or less than 5% of the gravity induced torque.

According to another aspect of the invention, the object is achieved by a robotic system comprising a robot arm having a proximal portion, a distal portion, a joint connecting said proximal and distal portions, a motor mounted in one of said portions, a transmission gear connecting the motor to the other one of said portions for driving rotation of the joint, a controller for controlling the robot arm to carry out a predetermined movement, wherein the controller is adapted to carry out at least steps b) and c) of the method described above.

Finally, the object is achieved by a computer software product comprising a plurality of instructions which, when executed by a processor, cause the processor to carry out at least steps b) and c) of the above method or to operate as the controller in the above robotic system.

Further features and advantages of the invention will become apparent from the subsequent description of embodiments, referring to the appended drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for assessing kinematic error in a joint that rotatably connects a proximal portion and a distal portion of a robot arm, the joint having associated with it a motor mounted in one of the portions and coupled to the other one of the portions for driving rotation of the joint by a transmission gear having a reduction ratio, and a sensor for measuring the rotation of the joint, the method comprising:
a) determining a movement of the robot arm in which the joint, while being rotated from a start angle to an end angle, is subject to a constant gravity-induced torque;
b) controlling execution of the movement and controlling the joint to rotate from the start angle to the end angle at a constant speed;
c) detecting speed fluctuations of the joint while it is being rotated from the start angle to the end angle; and
d) estimating the kinematic error based on the speed fluctuations.

2. The method of claim 1, wherein the sensor is an angle sensor associated with an output shaft of the transmission gear.

3. The method of claim 1, wherein detecting a speed fluctuation comprises determining an angle of an output shaft of the motor, calculating therefrom an expected angle of the joint using the reduction ratio of the transmission gear, and determining a difference between the expected angle and an angle measured by said sensor.

4. The method of claim 1, wherein the reduction ratio of the transmission gear is high enough to require several revolutions of the motor for rotating the joint from the start angle to the end angle.

5. The method of claim 1, wherein the movement is chosen so that at least while rotating from the start angle to the end angle the joint has a vertical axis of rotation.

6. The method of claim 1, wherein the joint is a first joint and the robot arm comprises at least one second joint and the movement is chosen so that at least while rotating the first joint from the start angle to the end angle the first and second joints have parallel axes of rotation, and a rotation speed of the second joint is matched to that of the first joint so that the gravity-induced torque to which the first joint is subjected is constant.

7. The method of claim 6, wherein the axes of rotation are horizontal.

8. The method of claim 6, wherein the second joint is in the proximal portion and the rotation of the second joint is identical in speed but opposite in direction to the rotation of the first joint.

9. The method of claim 6, wherein the second joint is in the distal portion, the rotation of the second joint is opposite in direction to the rotation of the first joint, and the speed of rotation of the second joint is controlled so as to maintain constant a lateral offset between the center of gravity of the distal portion and the axis of the first joint.

10. A robotic system, comprising:
a robot arm having a proximal portion, a distal portion, a joint connecting said proximal and distal portions, a motor mounted in one of the portions, a transmission gear connecting the motor to the other one of the portions for driving a rotation of the joint;
a controller for controlling the robot arm to carry out a pre-determined movement, wherein the controller is adapted to carry out at least:
controlling execution of the movement and controlling the joint to rotate from the start angle to the end angle at a constant speed; and
detecting speed fluctuations of the joint while it is being rotated from the start angle to the end angle.

11. The robotic system of claim 10, wherein the sensor is an angle sensor associated with an output shaft of the transmission gear.

12. The robotic system of claim 10, wherein the controller comprises a trajectory generator for outputting, based on a predetermined trajectory which maps successive instants in time onto associated desired rotation angles of the joint or its associated motor, at a given instant in time, a position command specifying the desired rotation angle associated with said given instant, and a position controller for adjusting a rotation angle of the joint or the motor to a position command received, wherein the controller is adapted to assess, based on said speed fluctuations, a kinematic error associated with a given angle of the joint, and input to the position controller, as said position command, the desired rotation angle corrected by its associated kinematic error.
